(19) United States
(12) Patent Application Publication
(10) Pub. No.: US 2010/0069125 A1
(43) Pub. Date: Mar. 18, 2010

(54) TRANCEIVER AND TRANSCEIVING METHOD IN UWB SYSTEM FOR FREQUENCY SHARING

(75) Inventors: Young-Keun Yoon, Choongcheongbuk-do (KR); Heon-Jin Hong, Daejeon-city (KR); Chang-Joo Kim, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/447,281

(22) PCT Filed: Jun. 13, 2007
(86) PCT No.: PCT/KR2007/002854

§ 371 Date: Apr. 27, 2009

(30) Foreign Application Priority Data
Nov. 16, 2006 (KR) 10-2006-0113481

(51) Int. Cl. H04B 1/40

(52) U.S. Cl. 455/571

(57) ABSTRACT

Provided are a transceiver and a transceiving method for use in an ultra wide band system for frequency sharing. The transceiver for use in an ultra wide band system for reducing interference that can be generated by an external system includes an external signal detector which detects an external signal generated from the external system, and a transmission signal controller which determines a power level of a transmission signal to be transmitted by the transceiver based on a power level of the detected external signal, in the case where an external signal using the same frequency channel as the ultra band system is detected, wherein the ultra wide band system and the external system are in a frequency sharing environment.

### TECHNICAL FIELD

The present invention relates to a transceiver and a transceiving method in an ultra wide band (UWB) system for frequency sharing, and more particularly, to a transceiver and a transceiving method in an UWB system capable of frequency sharing with an external device by selectively controlling transmission power in order to reduce an interference effect that can be generated by the external device.

### BACKGROUND ART

Referring to Korean Patent Application No. 10-2003-0029130 (‘UWB transceiver for dynamically reducing interference and transceiving method therefor’, filed on Nov. 16, 2006), a conventional ultra wide band (UWB) transceiver includes a stop band filter or a low noise amplifier (LNA) for each frequency channel band, and when a signal of a conventional communication system using the corresponding frequency band is detected, the appropriate stop band filter is turned on or the LNA is turned off in order to protect an external system from an interference effect caused by the UWB transciever.

By using a constitution which turns on and off transmission power in a frequency band overlapping with a frequency band of a wireless communication, interference in a UWB system that can be generated in the frequency band overlapping with the frequency band of the wireless communication can be prevented.

That is, when the frequency bands entirely overlap each other, transmission in the UWB system is completely cut off so that an interference effect is not generated in the external system.

However, in the UWB system using the corresponding frequency channel, the frequency channel should be moved to another frequency channel or the transmission should be stopped for a while.

### DISCLOSURE OF INVENTION

### Technical Problem

The present invention provides a transceiver and a transceiving method in an ultra wide band (UWB) system for reducing interference generated by an external system due to an external apparatus.

### Technical Solution

According to an aspect of the present invention, there is provided a transceiver for use in an ultra wide band (UWB) system for reducing interference that can be generated by an external system, wherein the ultra wide band system and the external system are in a frequency sharing environment, the transceiver comprising: an external signal detector which detects an external signal generated by the external system; and a transmission signal controller which determines a power level of a transmission signal to be transmitted by the transceiver based on a power level of the detected external signal, in the case where an external signal using the same frequency channel as the ultra band system is detected.

According to another aspect of the present invention, there is provided a transceiving method for use in an ultra wide band system for reducing interference that can be generated by an external system, wherein the ultra wide band system and the external system are in a frequency sharing environment, the transceiving method comprising: an external signal detection operation which detects an external signal generated by the external system; and a transmission signal control operation which determines a power level of a transmission signal to be transmitted by the transceiver based on a power level of the detected external signal in the case where an external signal using the same frequency channel as the ultra band system is detected.

### ADVANTAGEOUS EFFECTS

As described above, the interference probability is decreased in the present invention and thus the UWB system and the external system can share the same frequency channel simultaneously without significant interference.

As described above, using the transceiver and the transceiving method of the UWB system for frequency sharing according to the present invention, an interference effect generated in the UWB system due to an external system can be remarkably reduced.

Since the interference effect generated in the UWB system is reduced, the UWB system and the external system can share the same frequency channel without significant interference in a frequency sharing environment.

### DESCRIPTION OF DRAWINGS

FIG. 1 is a block diagram illustrating a transceiver in an ultra wide band (UWB) system according to an embodiment of the present invention;

FIG. 2 is a diagram illustrating a transmission signal controller of a transceiver in an

UWB system according to an embodiment of the present invention;

FIG. 3 is a flowchart illustrating a transceiving method in an UWB system according to an embodiment of the present invention;

FIG. 4 is a flowchart illustrating a transmission signal control operation of a transceiving method in an UWB system according to an embodiment of the present invention;

FIG. 5 is a flowchart illustrating a duty cycle control operation of a transceiving method in an UWB system according to an embodiment of the present invention; and

FIG. 6 is a graph illustrating an interference reduction effect according to an embodiment of the present invention.

### BEST MODE

According to an aspect of the present invention, there is provided a transceiver for use in an ultra wide band (UWB) system for reducing interference that can be generated by an external system, wherein the ultra wide band system and the external system are in a frequency sharing environment, the transceiver comprising: an external signal detector which detects an external signal generated by the external system; and a transmission signal controller which determines a power level of a transmission signal to be transmitted by the transceiver based on a power level of the detected external signal, in the case where an external signal using the same frequency channel as the ultra band system is detected.

According to another aspect of the present invention, there is provided a transceiving method for use in an ultra wide band system for reducing interference that can be generated by an external system, wherein the ultra wide band system and the external system are in a frequency sharing environment, the transceiving method comprising: an external signal detection operation which detects an external signal generated by the external system; and a transmission signal control operation which determines a power level of a transmission signal to be transmitted by the transceiver based on a power level of the detected external signal in the case where an external signal using the same frequency channel as the ultra band system is detected.

### MODE FOR INVENTION

Hereinafter, the present invention will be described more fully with reference to the accompanying drawings, in which exemplary embodiments of the invention are shown.

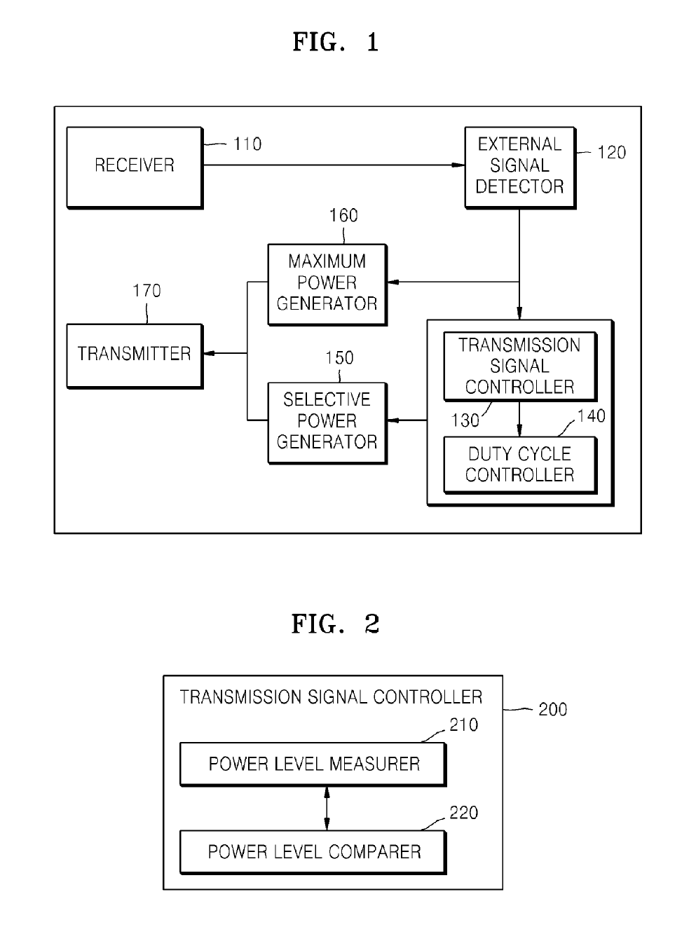

FIG. 1 is a block diagram illustrating a transceiver for use in an ultra wide band

(UWB) system according to an embodiment of the present invention. Referring to FIG. 1, the transceiver according to the current embodiment includes a receiver 110, an external signal detector 120, a transmission signal controller 130, a duty cycle controller 140, a selective power generator 150, a maximum power generator 160, and a transmitter 170.

The receiver 110 receives an external signal, which is a signal transmitted from an external device such as a similar UWB system or a heterogeneous communication system.

The external signal detector 120 checks whether the external signal uses the same frequency channel as the UWB system.

The transmission signal controller 130 determines a power level of a transmission signal of the UWB system based on a power level of the detected external signal, when the external signal using the same frequency channel as the UWB system is detected.

The selective power generator 150 generates a power level of the transmission signal based on the power level determined in the transmission signal controller 130.

The maximum power generator 160 generates the maximum power level of the transmission signal when no external signal using the same frequency channel as the UWB system is detected.

The transmitter 170 transmits the transmission signal, in which the power is selectively regulated, or the transmission signal having the maximum power is transmitted.

FIG. 2 is a diagram illustrating a transmission signal controller 200 of a transceiver in an UWB system according to an embodiment of the present invention. Referring to FIG. 2, the transmission signal controller 200 includes a power level measurer 210 and a power level comparer 220.

The power level measurer 210 measurers a power level of an external signal (a signal generated by an external system) using the same frequency channel as the UWB system.

The power level comparer 220 determines a power level of the transmission signal by comparing the power level of the external signal and a preset threshold power level of the transmission signal.

That is, the power level comparer 220 compares a minimum threshold signal power level Pmin or a maximum threshold signal power level Pmax of the UWB system with a power level A of the external signal in order to determine an output power level (Pmin, A, or Pmax) of the transmission signal of the UWB system. Hereinafter, this will be described in detail.

Herein, A is the power level of the external signal, Pmin is the minimum threshold signal power level of the UWB system, Pmax is the maximum threshold signal power level of the UWB system, Ptpc is a power level of the transmission signal of the UWB system determined by the power level comparer 220.

When A<Pmin, Ptpc is Pmin. When Pmin<A<Pmax, Ptpc is A. When A>Pmax, Ptpc is Pmax.

That is, when the power level of the external signal A is smaller than a predetermined minimum threshold power level Pmin, the power level of the transmission signal Ptcp is determined to be the minimum threshold power level Pmin.

When the power level A of the external signal is larger than the minimum threshold power level Pmin and smaller than a predetermined maximum threshold power level Pmax, the power level of the transmission signal Ptcp is determined to be the same as the power level A of the external signal.

When the power level A of the external signal is larger than the maximum threshold power level Pmax, the power level of the transmission signal Ptcp is determined to be the maximum threshold power level Pmax.

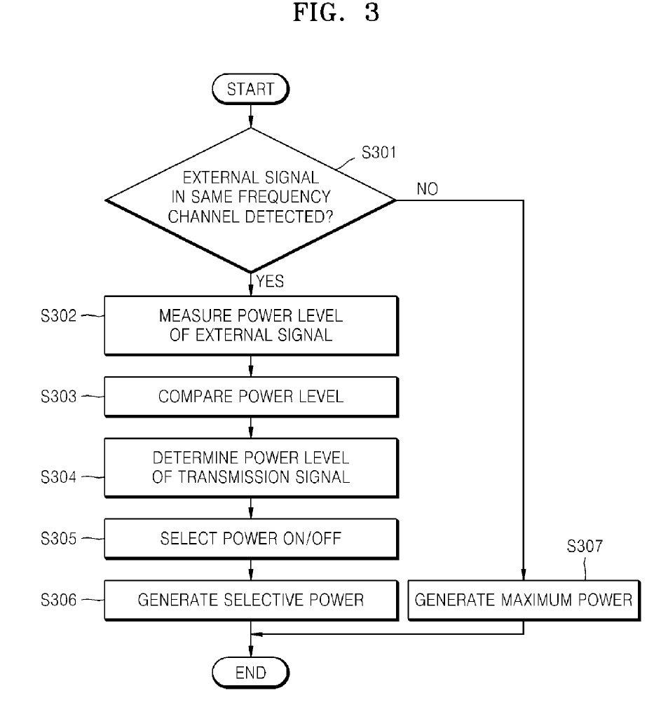

FIG. 3 is a flowchart illustrating a transceiving method in an UWB system according to an embodiment of the present invention. FIG. 3 illustrates the transceiving method in the UWB system for reducing an interference effect that can be generated by an external system, wherein the UWB system and the external system are in a frequency sharing environment.

First, it is determined whether an external signal generated from the external system exists. When an external signal using the same frequency channel as the UWB system is detected, a power level of a transmission signal of the UWB system is determined based on a power level of the detected external signal. Hereinafter, this will be described in detail.

In operation S301, it is determined whether an external signal using the same frequency channel as the UWB system is detected.

When an external signal using the same frequency channel as the UWB system is detected, the power level of the external signal using the same frequency channel is measured in operation 302.

The measured power level of the external signal and preset threshold power levels of the transmission signal are compared in operation S303 and the power level of the transmission signal is determined in operation S304.

An embodiment illustrating conditions for determining the power level of the transmission signal is as follows. When the power level of the external signal is smaller than a predetermined minimum threshold power level, the power level of the transmission signal is determined to be the minimum threshold power level.

When the power level of the external signal is larger than the minimum threshold power level and smaller than a predetermined maximum threshold power level, the power level of the transmission signal is determined to be the same as the power level of the external signal. When the power level of the external signal is larger than the maximum threshold power level, the power level of the transmission signal is determined to be the maximum threshold power level.

In operation S305, turning on/off of the transmission signal is selected based on a preset duty cycle. In operation S306, the power level of the transmission signal is selectively generated based on the power level determination of operation S304.

When no external signal using the same frequency channel as the UWB system is detected, the maximum power level that can be generated for the transmission signal is generated in operation S307, and then the transmission signal is transmitted.

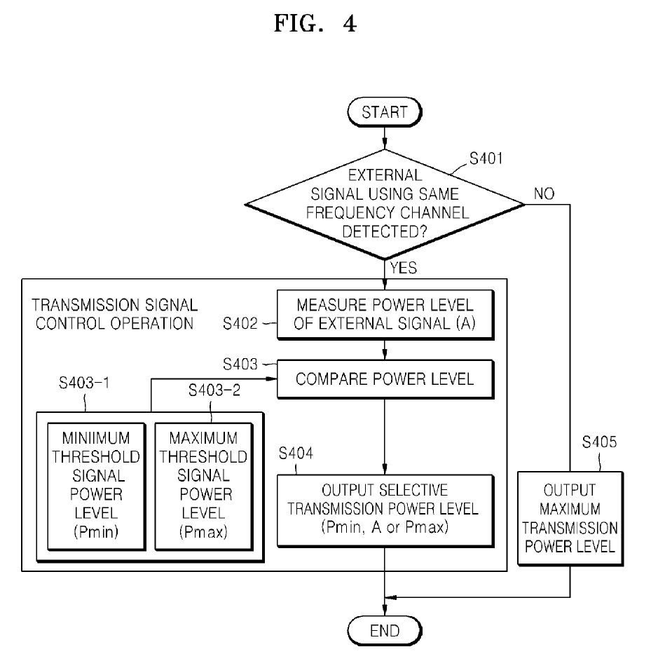

FIG. 4 is a flowchart illustrating a transmission signal control operation of a transceiving method of an UWB system according to an embodiment of the present invention.

Referring to FIG. 4, in the transmission signal control operation, a power level A of an external signal is measured, then the power level A of the external signal and a threshold power level of a transmission signal are compared, and as such power is selectively generated.

First, it is checked whether an external signal using the same frequency channel as the UWB system is received in operation S401. When an external signal using the same frequency channel is received, the received power level A of the external signal is measured in operation S402.

The power level A of the external signal is compared with a preset threshold power levels Pmin and Pmax of the transmission signal in order to determine the power level of the transmission signal in operation S403.

That is, the power level A of the external signal and the minimum threshold signal power level Pmin are compared in operation S403-1 and/or the power level A of the external signal and the maximum threshold signal power level Pmax are compared in operation S403-2 in order to determine an output power level (Pmin, A, or Pmax) of the transmission signal of the UWB system. Hereinafter, this will be described in detail.

Herein, A is the power level of the external signal, Pmin is the minimum threshold signal power level of the UWB system, Pmax is the maximum threshold signal power level of the UWB system, and Ptpc is the determined output power level of the transmission signal of the UWB system.

When A<Pmin, Ptpc is Pmin. When Pmin<A<Pmax, Ptpc is A. When A>Pmax, Ptpc is Pmax.

The power level of the transmission signal is selectively outputted in operation S404 based on the determined output power level (Pmin, A, or Pmax) of the transmission signal. When an external signal using the same frequency channel as the UWB system is not detected a transmission signal having the maximum power level Pmax can be generated and outputted in operation S405.

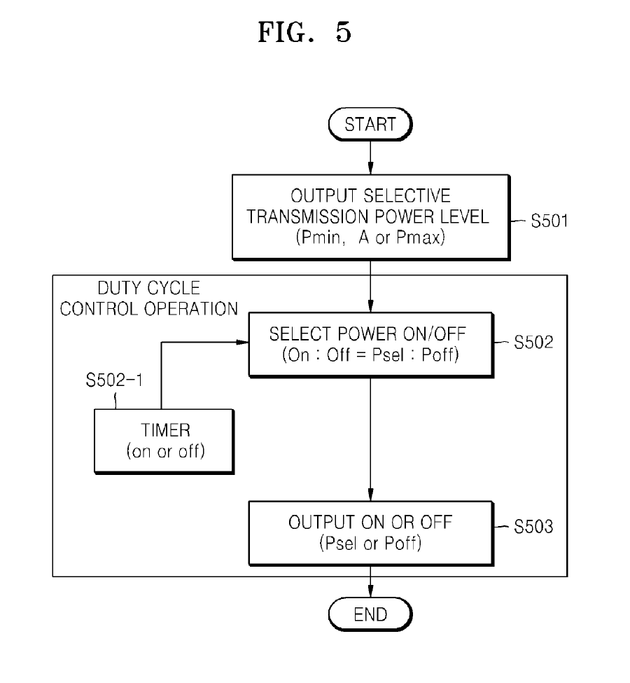

FIG. 5 is a flowchart illustrating a duty cycle control operation of a transceiving method of an UWB system according to an embodiment of the present invention.

The duty cycle control operation uses a transmission power on/off selection switch, wherein an on/off switching ratio is regulated in operation S502-1 by applying a preset duty cycle and via a control signal generated by a timer.

First, a power level of a transmission signal is selectively outputted in operation S501 based on the output power level (Pmin, A, or Pmax) of the transmission signal determined in the transmission signal control operation.

The on/off switching ratio is regulated in operation S502 by applying the preset duty cycle and via the control signal generated by the timer.

In operation S503, an output of the duty cycle control operation is Psel when the transmission power is turned on, and an output of the duty cycle control operation is Poff when the transmission power is turned off.

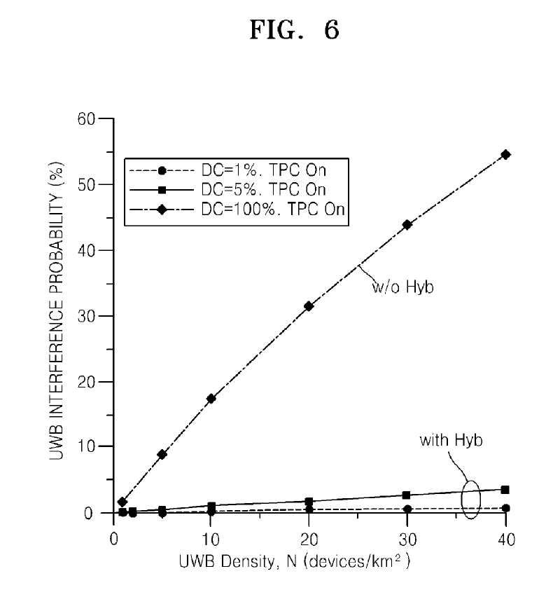

FIG. 6 is a graph illustrating an interference reduction effect according to an embodiment of the present invention.

Referring to FIG. 6, UWB density (devices/km²) plotted along the x-axis and interference probability (%) of UWB apparatuses is plotted along the y-axis.

The graph of FIG. 6 illustrates the UWB density and interference probability with a similar (or dissimilar) apparatus (or system) in the UWB apparatus. A duty cycle (DC=100%) denotes a case when the duty cycle is not applied.

Referring to FIG. 6, the result (with Hyb) using the transmission signal control (TPC) and the duty cycle (DC) control according to the present invention has remarkably lower interference probability than the result (w/o Hyb) only using the transmission signal control.

As described above, the interference probability is decreased in the present invention and thus the UWB system and the external system can share the same frequency channel simultaneously without significant interference.

The invention can also be embodied as computer readable code on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, using the transceiver and the transceiving method of the UWB system for frequency sharing according to the present invention, an interference effect generated in the UWB system due to an external system can be remarkably reduced.

Since the interference effect generated in the UWB system is reduced, the UWB system and the external system can share the same frequency channel without significant interference in a frequency sharing environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention provides a transceiver and a transceiving method in an ultra wide band (UWB) system for reducing interference generated by an external system due to an external apparatus.

1. A transceiver for use in an ultra wide band (UWB) system for reducing interference that can be generated by an external system, wherein the ultra wide band system and the external system are in a frequency sharing environment, the transceiver comprising:
an external signal detector which detects an external signal generated by the external system; and
a transmission signal controller which determines a power level of a transmission signal to be transmitted by the transceiver based on a power level of the detected external signal, in the case where an external signal using the same frequency channel as the ultra band system is detected.

2. The transceiver of claim 1, further comprising a maximum power generator which generates the transmission signal at a maximum power level when no external signal is detected.

3. The transceiver of claim 1, further comprising a selective power generator which generates the transmission signal at a power level based on the power level determined in the transmission signal controller.

4. The transceiver of claim 1, wherein the transmission signal controller comprises:
a power level measurer which measures a power level of the external signal using the same frequency channel; and
a power level comparer which determines a power level of the transmission signal by comparing the measured power level of the external signal and preset threshold power levels of the transmission signal.

5. The transceiver of claim 4, wherein the power level comparer determines the power level of the transmission signal to be a predetermined minimum threshold power level when the power level of the external signal is smaller than the minimum threshold power level, to be the same as the power level of the external signal when the power level of the external signal is larger than the minimum threshold power level and smaller than a predetermined maximum threshold power level, and to be the maximum threshold power level when the power level of the external signal is larger than the maximum threshold power level.

6. The transceiver of claim 1, further comprising a duty cycle controller which turns on/off the transmission signal based on a preset duty cycle.

7. A transceiving method for use in an ultra wide band system for reducing interference that can be generated by an external system, wherein the ultra wide band system and the external system are in a frequency sharing environment, the transceiving method comprising:
an external signal detection operation which detects an external signal generated by the external system; and
a transmission signal control operation which determines a power level of a transmission signal to be transmitted by the transceiver based on a power level of the detected external signal in the case where an external signal using the same frequency channel as the ultra band system is detected.

8. The transceiving method of claim 7, further comprising a maximum power generation operation which generates the transmission signal having a maximum power level when no external signal is detected.

9. The transceiving method of claim 7, further comprising a selective power generation operation which generates the power level of the transmission signal based on the power level determined in the transmission signal control operation.

10. The transceiving method of claim 7, wherein the transmission signal control operation comprises:
a power level measure operation which measures the power level of the external signal using the same frequency channel; and
a power level compare operation which determines the power level of the transmission signal by comparing the measured power level of the external signal and preset threshold power levels of the transmission signal.

11. The transceiving method of claim 10, wherein the power level compare operation determines the power level of the transmission signal to be a predetermined minimum threshold power level when the power level of the external signal is smaller than the minimum threshold power level, to be the same as the power level of the external signal when the power level of the external signal is larger than the minimum threshold power level and smaller than a predetermined maximum threshold power level, and to be the maximum threshold power level when the power level of the external signal is larger than the maximum threshold power level.

12. The transceiving method of claim 7, further comprising a duty cycle control operation which turns on/off the transmission signal based on a preset duty cycle.

13. A computer readable recording medium having recorded thereon a program for executing the method of any one of claims 7 through 12.
